(19) United States
(12) Patent Application Publication
(10) Pub. No.: US 2009/0187440 A1
(43) Pub. Date: Jul. 23, 2009

(54) METHOD AND SYSTEM FOR FACILITATING SECURITY MANAGEMENT IN AN ELECTRONIC NETWORK

(76) Inventors: Binny Gopinath Sreevas, Bangalore (IN); Sanjeev Kumar Agarwal, Bangalore (IN)

Correspondence Address: Global IP Services, PLLC, 198 F, 27th Cross, 3rd Block,, Jayanagar, Bangalore, Karnataka, 560011, IN

(21) Appl. No.: 12/017,053

(22) Filed: Jan. 21, 2008

(51) Int. Cl. G06Q 10/00

(52) U.S. Cl. 705/7

(57) ABSTRACT

A method and system for facilitating security management in an electronic network is provided. The method comprising obtaining a set of criteria corresponding to a security requirement of an enterprise. The method further comprising a set of entitlements verification components based on the set of criteria to obtain a customized set of entitlements verification components. The customized set of entitlements verification components comprises one or more entitlements verification components from the set of entitlements verification components. The method further comprising deploying the customized set of entitlements verification components in the electronic network.

### RELATED APPLICATIONS

Benefit is claimed under 35 U.S.C. 119(a)-(d) to Foreign application Ser. 670/MUM/2007 entitled “METHOD AND SYSTEM FOR FACILITATING SECURITY MANAGEMENT IN AN ELECTRONIC NETWORK” by Binny Gopinath Sreevas et al., filed on 3 Apr., 2007, which is herein incorporated in its entirety by reference for all purposes.

### FIELD OF THE INVENTION

The present invention generally relates to security management in an electronic network. More specifically, the present invention relates to facilitating security management by deploying a set of entitlements verification component in the electronic network.

### BACKGROUND OF THE INVENTION

In order to achieve and sustain stability in an enterprise, security management of the enterprise has become a critical factor in securing both material and non-material resources of the enterprise. The electronic network over which the security management solutions are deployed may constantly change and evolve, consequently stimulating an upgrade of the security management solution to a more complex security management solution. Entitlements verification mechanisms are offered by several security management solutions that provide an authorization framework for enterprise security in the electronic networks.

The complexity of entitlements verification mechanisms required by an enterprise depends upon the security requirements of the enterprise. For example, the enterprise may require a low level security management system with a simple entitlements verification mechanism. Alternatively, the enterprise may require a high level security management system having complex entitlements verification mechanisms. Therefore, it is vital to address the specific needs of enterprise security for optimizing the cost of installation and maintenance of security management solutions. However, the existing state of the art security management solutions require an enterprise to deploy security management solutions that can include entitlements verification mechanisms in their entirety.

When the existing security management system needs an upgrade, a new security layer may be required to be developed and deployed over the existing security management system of the enterprise for addressing the changes in the security requirements of the enterprise. For instance, providers of a security management system that newly needs data driven authorization features may integrate with an external rules engine that allows rules to be developed and executed by the rules engine.

Customizing the existing security management system or developing a new security layer over the existing security management system of the enterprise may necessitate additional financial and non-financial investments for the enterprise. The non-financial investments can be for example, identifying and employing human resources with necessary skills for customizing the existing security management system or alternatively developing the new security layer over the existing security management system of the enterprise.

Some of the state of the art security management solutions provide extensions to the existing security management systems in the form of security plug-ins for addressing changes in the security requirements of the enterprise. However, security plug-ins are simple authorization engines catering to medium level security requirements of the enterprise. When the size or the operations of an enterprise is scaled up, the security requirements of the enterprise may become more complex. Therefore, it may become crucial for a security management system to address the changes in the security requirements of the enterprise by considering the hierarchy structure of the enterprise.

### SUMMARY OF THE INVENTION

An embodiment of the present invention provides a method and system for facilitating security management in an electronic network.

The method for facilitating security management in the electronic network comprises obtaining a set of criteria, wherein the set of criteria corresponds to a security requirement of an enterprise. A set of entitlements verification components are customized based on the set of criteria to obtain a customized set of entitlements verification components. The set of entitlements verification components comprises at least a base entitlements verification component, a data-driven entitlements verification component, an enterprise hierarchy-based entitlements verification component and an attributes-based entitlements verification component. The customized set of entitlements verification components comprises one or more entitlements verification components selected from the set of entitlements verification components. The method further comprises deploying the customized set of entitlements verification components in the electronic network.

### BRIEF DESCRIPTION OF DRAWINGS

The foregoing objects and advantages of the present invention for a method and system for facilitating security management in an electronic network may be more readily understood by one skilled in the art with reference being had to the following detailed description of several preferred embodiments thereof, taken in conjunction with the accompanying drawings wherein like elements are designated by identical reference numerals throughout the several views, and in which:

FIG. 1 is a flowchart of a method for facilitating security management in an electronic network, in accordance with an embodiment of the present invention.

FIG. 2 is a flowchart for facilitating security management in an electronic network using a base entitlements verification component, in accordance with an embodiment of the present invention.

FIG. 3 is a flowchart for facilitating security management in an electronic network using a data-driven entitlements verification component, in accordance with an embodiment of the present invention.

FIG. 4 is a flow chart of a method for determining if one or more of at least one user profile and at least one role are entitled to the set of business objects, in accordance with an embodiment of the present invention.

FIG. 5 is a flowchart of a method for identifying one or more of business objects belonging to a set of business objects to which one or more of at least one user profile and at least one role are entitled, in accordance with an embodiment of the present invention.

FIG. 6 is a flowchart for facilitating security management using an enterprise hierarchy-based entitlements verification component in an electronic network, in accordance with an embodiment of the present invention.

FIG. 7 is a flowchart of a method for determining if one or more of at least one user profile, at least one role and at least one user profile assigned with at least one role are entitled to a set of business objects, in accordance with an embodiment of the present invention.

FIG. 8 is a flowchart for facilitating security management using an attributes-based entitlements verification component in an electronic network, in accordance with an embodiment of the present invention.

FIG. 9 is a flowchart of a method for creating one or more entitlement element maps, in accordance with an embodiment of the present invention is shown.

FIG. 10 is a flowchart of a method for determining if one or more of at least one user profile, at least one role and at least one user profile assigned with at least one role are entitled to a set of business objects, in accordance with an embodiment of the present invention.

FIG. 11 is a block diagram of a system for facilitating security management in an electronic network.

### DETAILED DESCRIPTION

Before describing in detail embodiments that are in accordance with the present invention, it should be observed that the embodiments reside primarily in combinations of method steps and system components related to a system and method for facilitating security management in an electronic network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

Various embodiments of the present invention provide a method and system for facilitating security management in an electronic network. A set of criteria pertaining to a security requirement of an enterprise is obtained. Based on the set of criteria, a set of entitlements verification components are customized. The set of entitlements verification components are customized to obtain a customized set of entitlements verification components. The customized set of entitlements verification components comprises one or more entitlements verification components from the set of entitlements verification components. Subsequent to customizing the set of entitlements verification components, the customized set of entitlements verification components are deployed in the electronic network.

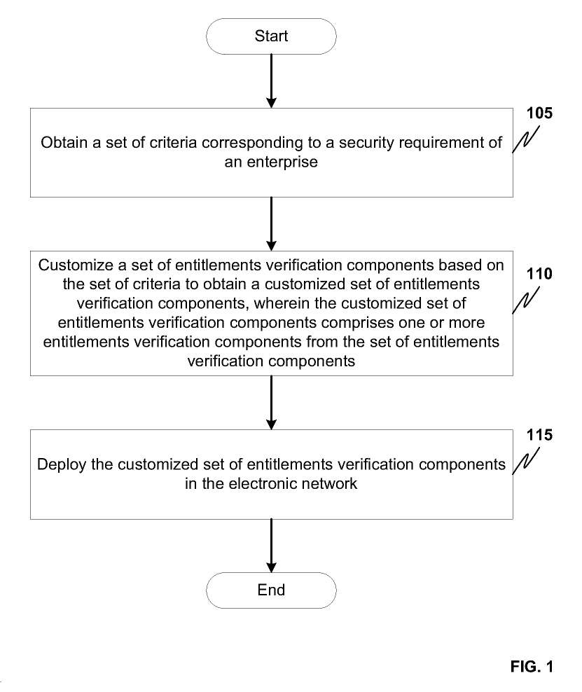

FIG. 1 is a flowchart of a method for facilitating security management in an electronic network, in accordance with an embodiment of the present invention. At step 105 a set of criteria corresponding to a security requirement of an enterprise is obtained. The set of criteria is obtained for the purpose of analyzing the deployment of security management solutions in the electronic network. In an embodiment of the present invention, the set of criteria can correspond to analyzing a list of user groups or roles that need to be defined in the security management solutions along with various other security management functions that will be accessible by each of users. The set of criteria may also include analyzing a list of users who can be given access to the security management solutions and the user groups or roles to which each of the users may belong, analyzing a list of rules and logic used for each of these rules based on which the above-mentioned user groups or roles or users may be granted access to various business objects that would be managed using the security management solutions.

Moreover, the set of criteria can also comprise analyzing the organizational structure of an enterprise and the access entitlements for various user groups, roles and users to perform various functions on a set of business objects that belong to different parts of the enterprise hierarchy structure and analyzing a list of attributes based on which entitlements can be provided to various business objects that would be managed using the security management solutions.

In an exemplary embodiment of the present invention, the set of criteria required for deploying security management solutions for an audit tracking enterprise can be, analyzing the authorizations of one or more audit officers in New York region who can edit and authorize all audit findings that are reported on all software development carried out within the New York region. Further, the set of criteria can include analyzing the authorizations of one or more audit officers who can view all audit findings that are reported on non-critical software development carried out within the United States and analyzing the authorizations of one or more audit officers who can view or edit or authorize audit findings that are reported on software development carried out outside the United States. Moreover, the set of criteria may also include analyzing the authorizations of one or more country audit officers in the United States who may have authorization to view, edit and authorize all audit findings that are reported on all critical and non-critical software development carried out within the United States.

Upon analyzing the set of criteria corresponding to the security requirements of the enterprise, a set of components pertaining to the security management solutions for deployment in the electronic network are identified. The set of components pertaining to the security management solutions can address the complexity corresponding to the levels and functionalities of the security management solutions required for managing the security of the enterprise. The set of components corresponding to the security management solutions may belong to a set of entitlements verification components. Therefore, the set of criteria corresponding to the security requirement of the enterprise are analyzed for deploying the set of entitlements verification components in the electronic network. In an embodiment of the present invention, the set of entitlements verification components comprises one or more of a base entitlements verification component, a data-driven entitlements verification component, an enterprise hierarchy-based entitlements verification component and an attributes based entitlements verification component.

At step 110, the set of entitlements verification components are customized on the basis of the set of criteria corresponding to the security requirement of the enterprise obtained at step 105. As a result a customized set of entitlements verification components is obtained. The customized set of entitlements verification components comprises one or more entitlements verification components from the set of entitlements verification components. Therefore, a security administrator can be facilitated to choose the one or more entitlements verification components from the set of entitlements verification components for deployment in the electronic network.

Consider a scenario, wherein the size of an enterprise is small. Accordingly, the security requirement of the enterprise can be different from the security requirement of a large enterprise. Therefore, one or more entitlements verification components can be selected and deployed in the electronic network instead of deploying the entire set of entitlements verification components. For example, in this scenario, a security administrator may choose to deploy only the base entitlements verification component by selecting the base entitlements verification component from the set of entitlements verification components. On the contrary, in case of a large enterprise, it may be required to choose each of the entitlements verification components from the set of entitlements verification components along with the base entitlements verification component for facilitating security management of the large enterprise in the electronic network.

The customized set of entitlements verification components obtained at step 110 are deployed in the electronic network at step 115. It would be apparent to a person skilled in the art that that each of the entitlements verification components can be treated as a security layer in the enterprise. Each of these security layers provides a modular entitlements verification architecture for facilitating enterprise security management.

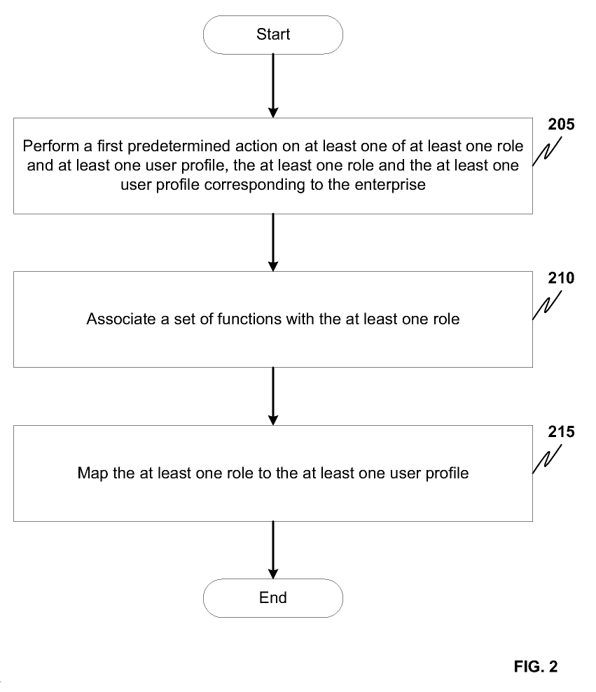

FIG. 2 is a flowchart for facilitating security management in an electronic network using a base entitlements verification component, in accordance with an embodiment of the present invention. The base entitlements verification component facilitates security management of an enterprise by providing basic role-based authorization mechanisms. For example, in an enterprise one or more employees may have roles assigned to them with respect to their job functions. Based on the assigned roles, the one or more employees can acquire permissions to perform one or more functions in an electronic network corresponding to the enterprise. At step 205, a first predetermined action corresponding to one or more of at least one role and at least one user profile are performed. The at least one role and the at least one user profile corresponds to the enterprise. In an embodiment of the present invention, the first predetermined action can be for example, but not limited to, a creating action, an editing action, an updating action, a searching action, an approving action and a rejecting action. For instance, the base entitlements verification component can facilitate a security administrator or other users to perform the first predetermined action.

The base entitlements verification component can facilitate the security administrator or other users to perform the first predetermined action corresponding to the at least one role. At step 210, the base entitlements verification component facilitates associating a set of functions with the at least one role. The set of functions may depend upon the context of activities corresponding to the organization of the enterprise. At step 215, the base entitlements verification component facilitates mapping the at least one role to the at least one user profile. Mapping the at least role to the at least one user profile is facilitated based on a first set of attributes corresponding to the at least one user profile and a second set of attributes corresponding to the at least one role.

The first set of attributes corresponding to the at least one user profile comprises a user identifier, a first name, a last name, a middle name, a display, an authorization status, a user profile comment, a title, an email identity, a supervisor, a record status, a created date, a last updated date, an approved or rejected date, a user profile active or inactive status, one or more user to role mappings and a default role. Table. 1 illustrates the characteristics of the first set of attributes corresponding to the at least one user profile in accordance with an embodiment of the present invention.

TABLE 1

| The first set | Type and | Mandatory | |
|---|---|---|---|
| of Attributes | Length | requirement | Description |
| User Identifier | Alphanumeric (20) | Yes | The user identifier is a unique identifier |
| | | | corresponding to a user profile |
| First Name | Alphanumeric (30) | Yes | The first name corresponds to the first |
| | | | name of a user profile |
| Last Name | Alphanumeric (30) | Yes | The last name corresponds to a surname of |
| | | | a user profile |
| Middle Name | Alphanumeric (30) | No | The middle name corresponds to the |
| | | | middle name of a user profile |
| Display name | Alphanumeric (60) | No | The display name is a name for display on |
| | | | a screen of a display device corresponding |
| | | | to a user profile. The base entitlements |
| | | | verification component facilitates |
| | | | overriding the default display name |
| | | | corresponding to a user profile |
| Authorization | Alphanumeric (1) | Yes | The authorization status denotes an |
| status | | | authorization approval or authorization |
| | | | rejection status corresponding to a user |
| | | | profile |
| User profile | Alphanumeric | No | The user profile comment denotes free |
| comments | (4096) | | form comments corresponding to a user |
| | | | profile |
| Title | Alphanumeric (30) | No | The title denotes the designation of a user |
| | | | profile in the enterprise |
| Email identity | Alphanumeric | Yes | An email identity corresponding to a user |
| | (100) | | profile |
| Supervisor | Selection | No | The supervisor can be another user profile |
| | | | designated as a supervisor for a user profile |
| Record status | Alphanumeric (20) | Yes | The record status denotes one of a created, |
| | | | modified and deleted status corresponding |
| | | | to a user profile |
| Created Date | Date | Yes | The created date denotes a date of creation |
| | | | of a user profile |
| Last Updated | Date | Yes | The last updated date denotes the last |
| | | | update date of a user profile |
| Approved/Rejected | Date | No | The approved or rejected date denotes a |
| Date | | | last date of approval or rejection of a user |
| | | | profile |
| User profile | Alphanumeric (1) | Yes | The user profile active or inactive status |
| Active status | | | denotes whether a user profile is in an |
| | | | active or inactive state |
| User to Role | Selection | No | The one or more user to role mappings |
| mapping | | | denotes one or more approved existing |
| | | | roles to which a user profile is entitled |
| Default role | Radio button | No | The default role denotes a single role |
| | across the roles | | selected from one or more existing roles |
| | selected | | corresponding to a user profile that can be |
| | | | displayed by the base entitlements |
| | | | verification component |

The second set of attributes corresponding to the at least one role comprises a role identifier, a role description, a role comment, a role active or inactive status and one or more role to function mappings. Table. 2 illustrates the characteristics of the second set of attributes corresponding to the at least one role in accordance with an embodiment of the present invention.

TABLE 2

| The second set of | Type and | Mandatory | |
|---|---|---|---|
| attributes | Length | requirement | Description |
| Role Identifier | Alphanumeric (20) | Yes | The role identifier denotes a |
| | | | unique identifier corresponding to |
| | | | a role |
| Role Description | Alphanumeric (40) | Yes | The role description denotes a |
| | | | description of a role |
| Role comment | Alphanumeric | | The role comment denotes free |
| | (4096) | | form comments corresponding to |
| | | | a role |
| Role active or inactive | Alphanumeric (1) | Yes | The role active or inactive status |
| status | | | denotes whether a role is in active |
| | | | or inactive state |
| Role to function mapping | Selection | No | The role to function mapping |
| | | | denotes one or more functions to |
| | | | which a role is entitled |

In an exemplary embodiment of the present invention, the base entitlements verification system facilitates the security administrator to create the at least one role, map the set of functions to the at least one role, create the at least one user profile, map the at least one role to the at least one user profile, obtain the at least one role and the corresponding set of functions to which the at least one role is entitled, assign the default role to the at least one user profile and obtain the at least one user profile and the corresponding one or more roles to which the at least one user profile is entitled. The base entitlements verification component stores the at least one user profile, the at least one role and the mappings corresponding to the at least one user profile and at least one role in a temporary storage area till the at least one user profile and the at least one role are approved or rejected.

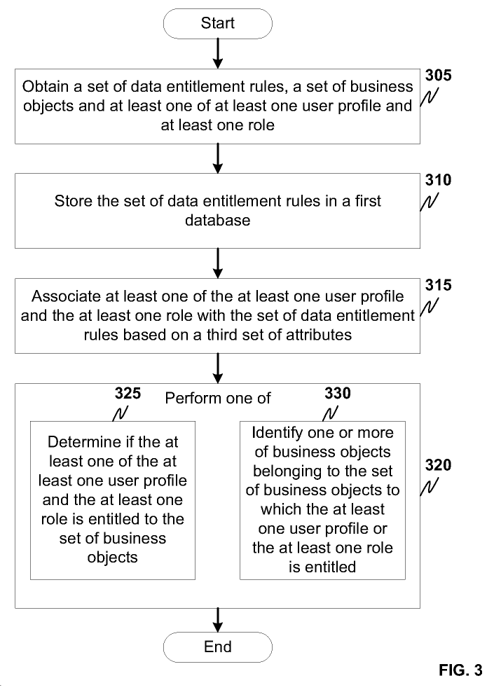

Referring to FIG. 3, a flowchart for facilitating security management in an electronic network using data-driven entitlements verification component, in accordance with an embodiment of the present invention is shown. At step 305, the data-driven entitlements verification component facilitates obtaining a set of data entitlement rules and a set of business objects. Also, one or more of at least one user profile and at least one role is obtained using the data-driven entitlements verification component. The set of data entitlement rules are obtained using the data-driven entitlements verification component based on a set of entitlement rule attributes. The set of entitlement rule attributes comprises a rule identifier, a rule description and a data rule. Table. 3 illustrates the characteristics of the set of entitlement rule attributes corresponding to the at least one user profile in accordance with an embodiment of the present invention.

TABLE 3

| The set of entitlement | Type and | Mandatory | |
|---|---|---|---|
| rule attributes | Length | requirement | Description |
| Rule Identifier | Alphanumeric (20) | Yes | The rule identifier denotes a |
| | | | unique identifier corresponding |
| | | | to each data entitlement rule |
| | | | belonging to the set of data |
| | | | entitlement rules |
| Rule Description | Alphanumeric (40) | Yes | The rule description |
| | | | corresponds to a description of |
| | | | a data entitlement rule |
| Data Rule | Large Text | Yes | The data rule represents a text |
| | | | corresponding to each data |
| | | | entitlement rule. |

In an exemplary embodiment of the present invention, the data rule corresponding to each data entitlement rule can be for example, a high level source code that may represent a function to aggregate the credit transactions pertaining to a customer of a bank and check whether the sum of the credit transactions exceeds a certain predefined limit. In an embodiment of the present invention, the data-driven entitlements verification component can comprise a parsing element that can parse the data rule corresponding to each data entitlement rule.

At step 310, the set of data entitlement rules obtained using the data-driven entitlements verification component is stored in an entitlement rules database. Further, at step 315 the set of data entitlement rules are associated with one or more of the at least one user profile and the at least one role based on a third set of attributes. In an embodiment of the present invention, the third set of attributes comprises a user identifier, a role identifier and a rule identifier. Table. 4 illustrates the characteristics the third set of attributes in accordance with an embodiment of the present invention.

TABLE 4

| The third set of | Type and | Mandatory | |
|---|---|---|---|
| attributes | Length | requirement | Description |
| User Identifier | Selection | Either user identifier or role | A user identifier corresponds to a |
| | | identifier is mandatory. Both | user profile and it denotes the user |
| | | the user identifier and the rule | profile to which the set of data |
| | | identifier can be specified at | entitlement rules is being mapped |
| Role Identifier | Selection | the same time. | A role identifier corresponds to a |
| | | | role and it denotes the role to |
| | | | which the set of entitlement rules |
| | | | is being mapped |
| Rule Identifier | Selection | Yes | A rule identifier corresponds to a |
| | | | data entitlement rule and it |
| | | | denotes the data entitlement rule |
| | | | to which a user profile and a role |
| | | | are being mapped |

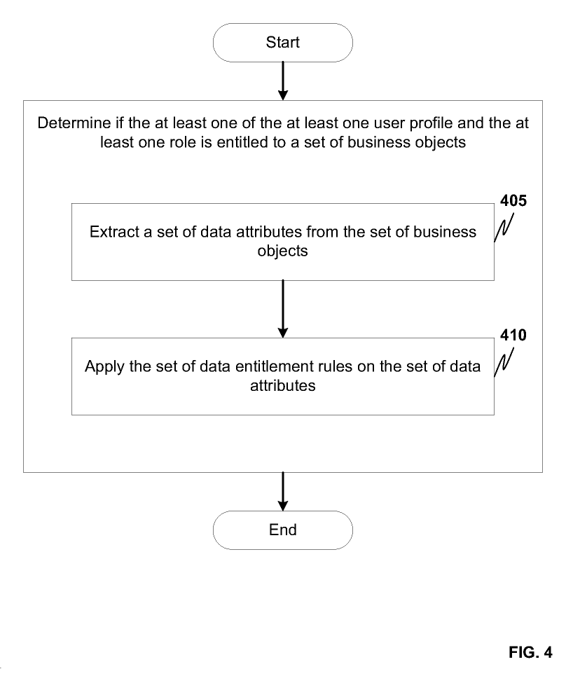

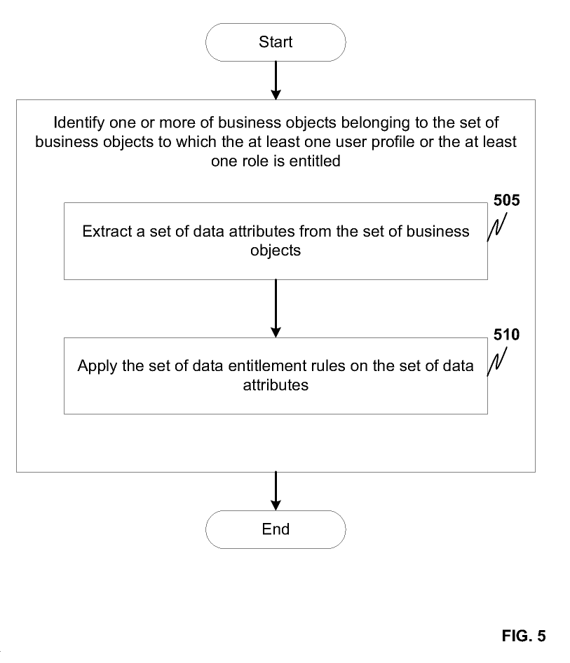

Moving forward, at step 320, an operation is performed to establish a correlation between a set of business objects and the at least one user profile and the at least one role. In an embodiment of the present invention, the operation can be determining if one or more of the at least one user profile and the at least one role is entitled to the set of business objects at step 325. The step of determining has been explained in detail in conjunction with FIG. 4. In another embodiment of the present invention, the operation can be identifying one or more business objects belonging to the set of business objects to which one or more of the at least one user profile and the at least one role is entitled at step 330. The step of identifying has been explained in detail in conjunction with FIG. 5

Turning to FIG. 4, a flow chart of a method for determining if one or more of the at least one user profile and the at least one role is entitled to the set of business objects, in accordance with an embodiment of the present invention is shown. At step 405, the data-driven entitlements verification component extracts a set of data attributes from the set of business objects. Upon extracting the set of data attributes from the set of business objects, at step 410, the data-driven entitlements verification component applies the set of data entitlement rules on the set of data attributes. As a result, one or more of the at least one user profile and the at least one role is entitled to the set of business objects. Each of a business object from the set of business objects can have one or more sets of fields. The one or more sets of fields will be accepted as a parameter by the data-driven entitlements verification component for evaluating the set of data entitlement rules, when the set of data entitlement rules are applied on the set of data attributes. The set of fields corresponding to each of the business object from the set of business objects can have a parameter name, a parameter class and a parameter type. Table. 5 illustrates the characteristics of the set of fields corresponding to each of the business object from the set of business objects in accordance with an embodiment of the present invention.

TABLE 5

| The set of | Type and | Mandatory | |
|---|---|---|---|
| fields | Length | requirement | Description |
| Parameter Name | Alphanumeric | No | The parameter name denotes a logical name |
| | (30) | | for the parameter |
| Parameter Class | Alphanumeric | No | The parameter class can be a programming |
| | (300) | | language class that contains the value of the |
| | | | parameter. During runtime of the data-driven |
| | | | entitlements verification component, the data- |
| | | | driven entitlements verification component |
| | | | will convert the value of the parameter to the |
| | | | corresponding programming language class. |
| | | | The conversion of the value of the parameter |
| | | | to the corresponding programming language |
| | | | class is performed prior to evaluating the |
| | | | application of the set of data entitlement rules |
| | | | on the set of data attributes. |
| Parameter Type | Alphanumeric | No | The parameter type indicates whether the |
| | (10) | | parameter is an input or an output |
| | | | corresponding to the set of data entitlement |
| | | | rules |

In an exemplary embodiment of the present invention, in a banking enterprise, Retail Relationship Officers (RROs) may have entitlements to access one or more customer profiles that have a monthly total credit transaction up to $25000. On the other hand, private banking relationship officers (PBROs) may have entitlements to access one or more customer profiles that have a monthly total credit transaction more than $25000. A transaction entitlement rule can be for example set up to return a value “True” if the monthly total credit transaction is greater than $25000 and “False” if the monthly total credit transaction is less than $25000.

When a customer profile and its corresponding set of credit transactions are passed along with at least one of a RRO role identifier and a PBRO role identifier to the data-driven entitlements verification component, the data-driven entitlements verification component extracts the set of credit transactions corresponding to the customer profile. Subsequent to the extraction of the set of credit transactions, the data-driven entitlements verification component applies the transaction entitlement rule on the set of credit transactions corresponding to the customer profile. Upon applying the transaction entitlement rule on the set of credit transactions, the data-driven entitlements verification component checks if the monthly total credit transaction of the customer profile is greater than $25000. If the monthly total credit transaction of the customer profile is greater than $25000, the data-driven entitlements verification component will return “True” for the PBRO role identifier and “False” for the RRO role identifier.

Referring to FIG. 5, a flowchart of a method for identifying one or more of business objects belonging to a set of business objects to which one or more of the at least one user profile and the at least one role is entitled, in accordance with an embodiment of the present invention is shown. At step 505, the data-driven entitlements verification component extracts a set of data attributes from the set of business objects. Upon extracting the set of data attributes from the set of business objects, at step 510, the data-driven entitlements verification component applies the set of data entitlement rules on the set of data attributes. As a result, one or more business objects are identified to which at least one or more of the at least one user profile and the at least one role is entitled.

Consider the exemplary embodiment of the present invention mentioned above corresponding to the banking enterprise. For instance, a set of customer profiles and the set of credit transactions corresponding to the set of customer profiles are passed along with at least one of the RRO role identifier and the PBRO role identifier to the data-driven entitlements verification component. The data-driven entitlements verification component extracts the set of credit transactions corresponding to the set of customer profiles. Subsequent to the extraction of the set of credit transactions corresponding to the set of customer profiles, the data-driven entitlements verification component applies the transaction entitlement rule on the set of credit transactions corresponding to the set of customer profiles.

Upon evaluating the application of the transaction entitlement rule on the set of credit transactions for the PBRO role identifier, the data-driven entitlements verification component will return a first subset of customer profiles, wherein each of the customer profiles belonging to the first subset of customer profiles will have total monthly credit transactions greater than $25000. The first subset of customer profiles belongs to the set of customer profiles. Similarly, on evaluating the application of the transaction entitlement rule on the set of credit transactions for the RRO role identifier, the data-driven entitlements verification component will return a second subset of customer profiles, wherein each of the customer profiles belonging to second the subset of customer profiles will have total monthly credit transactions less than $25000. The second subset of customer profile belongs to the set of customer profiles.

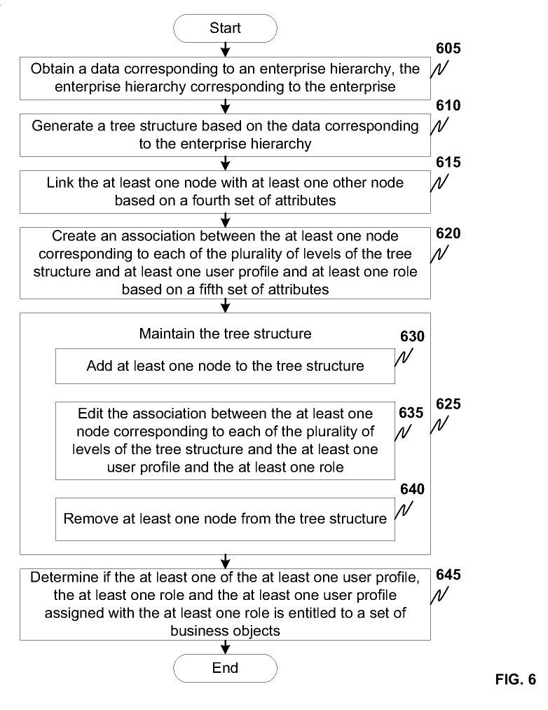

Turning to FIG. 6, a flowchart for facilitating security management using an enterprise hierarchy-based entitlements verification component in an electronic network, in accordance with an embodiment of the present invention is shown. At step 605, a data corresponding to an enterprise hierarchy corresponding to the enterprise is obtained using the enterprise hierarchy-based entitlements verification component. The data can be for example, but not limited to, one or more branches of the enterprise, one or more segments corresponding to the one or more branches and one or more sub-segments corresponding to the one or more segments. The one or more branches, one or more segments and one or more sub-segments corresponding to the enterprise denote levels of the enterprise hierarchy. On obtaining the data corresponding to the enterprise hierarchy, the enterprise hierarchy-based entitlements verification component generates a tree structure at step 610. The tree structure corresponding to the enterprise hierarchy comprises a plurality of levels. Each of the plurality of levels of the tree structure comprises one or more node entities.

The enterprise hierarchy-based entitlements verification component generates the trees structure corresponding to the enterprise hierarchy based on a set of entity attributes. The set of entity attributes comprises an entity identifier, an entity name, an entity type, an entity status and an entity authorization status. Table. 6 illustrates the characteristics of the set of entity attributes corresponding to the hierarchy structure of the enterprise in accordance with an embodiment of the present invention.

TABLE 6

| The set of entity | Type and | Mandatory | |
|---|---|---|---|
| attributes | Length | requirement | Description |
| Entity Identifier | Alphanumeric (20) | Yes | The entity identifier denotes a unique |
| | | | identifier for each entity corresponding |
| | | | to an enterprise hierarchy |
| Entity Name | Alphanumeric | Yes | The entity name denotes a name or a |
| | (100) | | description of one or more entities |
| | | | corresponding to an enterprise hierarchy |
| Entity Type | Selection | Yes | The entity type specifies a class type of |
| | | | a node corresponding to a plurality of |
| | | | levels of a tree structure |
| Entity Status | Alphanumeric (10) | Yes | The entity status specifies if one or |
| | | | more nodes corresponding to a plurality |
| | | | of levels of a tree structure is in active |
| | | | or inactive state |
| Entity authorization | Alphanumeric (10) | Yes | The entity authorization status indicates |
| status | | | whether one or more nodes |
| | | | corresponding to a plurality of levels of |
| | | | a tree structure is in an “approved”, |
| | | | “rejected” or “pending” state |

At step 615, the enterprise hierarchy-based entitlements verification component facilitates linking the one or more nodes with one or more other nodes based on a fourth set of attributes. The fourth set of attributes comprises a parent entity identifier, a child entity identifier, a description, a node status and a node authorization status. Table. 7

TABLE 7

| The fourth set | Type and | Mandatory | |
|---|---|---|---|
| of attributes | Length | requirement | Description |
| Parent Entity | Selection | Yes | The parent entity denotes one or more |
| Identifier | | | nodes corresponding to a plurality of |
| | | | levels of a tree structure |
| Child Entity | Selection | Yes | The child entity identifier denotes one or |
| Identifier | | | more other nodes corresponding to the |
| | | | plurality of levels of the tree structure |
| Description | Alphanumeric | | The description specifies description or |
| | (100) | | notes pertaining to one or more nodes |
| | | | being attached to the plurality of levels of |
| | | | the tree structure |
| Node status | Alphanumeric (10) | Yes | The node status specifies whether one or |
| | | | more nodes corresponding to the plurality |
| | | | of levels of the tree structure are active or |
| | | | inactive |
| Node authorization | Alphanumeric (10) | Yes | The node authorization status denotes if |
| status | | | the linking of one or more nodes with one |
| | | | or more other nodes is in an “approved”, |
| | | | “rejected” or “pending” state |

At 620, the enterprise hierarchy-based entitlements verification component facilitates creating an association between one or more nodes corresponding to each of the plurality of levels of the tree structure and one or more of at least one user profile and at least one role, based on a fifth set of attributes. The fifth set of attributes comprises a user identifier, a role identifier, a node path identifier and a scope. Table. 8 illustrates the characteristics of the fifth set attributes in accordance with an embodiment of the present invention.

TABLE 8

| The fifth set of | Type and | Mandatory | |
|---|---|---|---|
| attributes | Length | requirement | Description |
| User Identifier | Selection | Either user identifier | The user identifier denotes a user |
| | | or role identifier is | profile to which a node corresponding |
| | | mandatory. Both the | to the plurality of levels of the tree |
| | | user identifier and the | structure is being mapped |
| Role Identifier | Selection | role identifier can be | The role identifier denotes a role to |
| | | specified at the same | which a node corresponding to the |
| | | time. | plurality of levels of the tree structure |
| | | | is being associated with |
| Node Path Identifier | Selection | Yes | The node path identifier can be of type |
| | | | selection and denotes a node |
| | | | corresponding to the plurality of levels |
| | | | of the tree structure to which one or |
| | | | more of a user profile and a role have |
| | | | entitlements |
| Scope | Selection | Yes | The scope denotes the level of |
| | | | entitlement of a user profile assigned |
| | | | with a role, to the one or more node |
| | | | entities in the tree structure |
| | | | corresponding to the enterprise |
| | | | hierarchy |

The enterprise hierarchy-based entitlements verification component facilitates attaching a scope to the association between the at least one node and the at least one user profile. The at least one user profile is assigned with the at least one role. Further, the scope provides the at least one user profile with one or more of a self-access privilege, an all-access privilege and a type-based access privilege. The self-access privilege provides access to the one or more nodes that are associated with the at least one user profile assigned with the at least one role. Further, during runtime the at least one user profile assigned with the at least one role is required to be associated with a set of business objects prior to accessing the one or more nodes. The set of business objects is associated with the one or more nodes.

The at least one user profile can have access to one or more of other nodes if the at least one user profile has the all-access privilege. Moreover, access to one or more portions of the tree structure is provided by the type-based access privilege in which the one or more portions of the tree structure comprise one or more nodes. Additionally, the at least one user profile can have access to one or more business objects associated to the one or more of other nodes, if the at least one user profile has the self access privilege and the one or more business objects are explicitly assigned to the at least one user profile. In an exemplary embodiment of the present invention, a customer business object is required to be assigned to a RRO before facilitating the RRO to access the customer business object. However, a branch officer may have access to all customer business objects corresponding to a branch assigned to the branch officer, even if the customer business object is not specifically assigned to the branch officer.

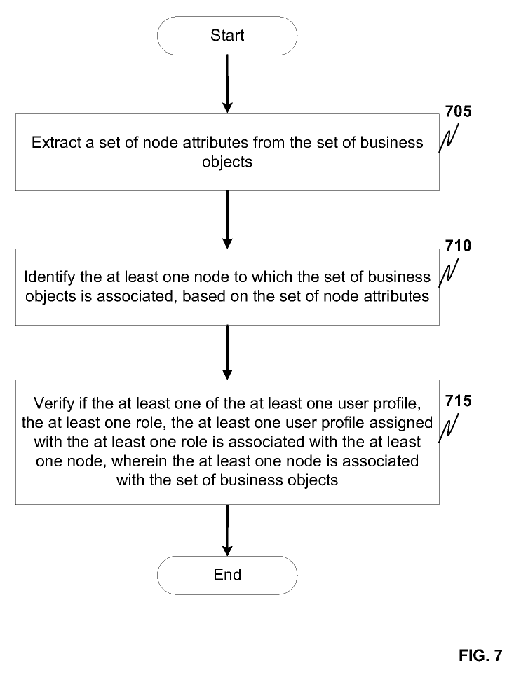

At step 625, the enterprise hierarchy-based entitlements verification component facilitates maintaining the tree structure corresponding to the enterprise hierarchy. Maintaining the tree structure comprises performing an adding, editing or deleting operation on the tree structure corresponding to the enterprise hierarchy. At step 630, the enterprise hierarchy-based entitlements verification component facilitates adding one or more nodes to the tree structure. Further, at step 635, the enterprise hierarchy-based entitlements verification component facilitates editing the association between the at least one node corresponding to each of the plurality of levels of the tree structure and the at least one user profile and the at least one role. Similarly, at step 640, the enterprise hierarchy-based entitlements verification component facilitates removing one or more nodes from the tree structure. A set of business objects to which the at least one user profile, the at least one role and the at least one role assigned with the at least one role is determined at step 645. This is further explained in detail in conjunction with FIG. 7.

FIG. 7 is a flowchart of a method for determining if one or more of at least one user profile, at least one role and at least one user profile assigned with at least one role are entitled to a set of business objects, in accordance with an embodiment of the present invention. When the set of business objects is provided as an input to the enterprise hierarchy-based entitlements verification component along with one or more of at least one user profile, at least one role and at least one user profile assigned with at least one role, a set of node attributes is extracted from the set of business objects. The extraction of the set of node attributes by the enterprise hierarchy-based entitlements verification component performed at step 705. Subsequent to the extraction of the set of node attributes, one or more nodes to which the set of business objects is associated, is identified at step 710. The identification of the one or more nodes is performed based on the node attributes.

At step 715, the association of the one or more of the at least one user profile, the at least one role or the at least one user profile assigned with the at least one role, with the one or more nodes is verified. Upon verification, the enterprise hierarchy-based entitlements verification component determines if the one or more of the at least one user profile, the at least one role or the at least one user profile assigned with the at least one role is entitled to the set of business objects.

In an exemplary embodiment of the present invention, the enterprise hierarchy-based entitlements verification component can generate a tree structure corresponding to an enterprise hierarchy having 4 levels including a root node of the tree structure. The first level of the tree structure may correspond to a business line of the enterprise having two nodes. For example, one of the two nodes may represent an agriculture business line corresponding to the enterprise and the other node may represent a steel business line corresponding to the enterprise. The agriculture business line may be distributed in three different countries such as Austria, Germany and the US. The three different countries can be denoted as three country nodes of the tree structure corresponding to the enterprise, further forming the third level of the tree structure. There can be one more cost centers corresponding to each of the three country nodes and the one or more cost centers can be represented as cost center nodes forming the fourth level of the tree structure corresponding to the enterprise. Each node of the tree structure corresponding to the enterprise can be associated with a plurality of user profiles assigned with at least one role. During runtime of the enterprise hierarchy-based entitlements verification component, when a user having a certain user profile and at least one role seeks to access a cost center node corresponding to the country node Austria, the enterprise hierarchy-based verification component verifies the entitlements of the user profile corresponding to the user and accordingly allows or denies access to the user.

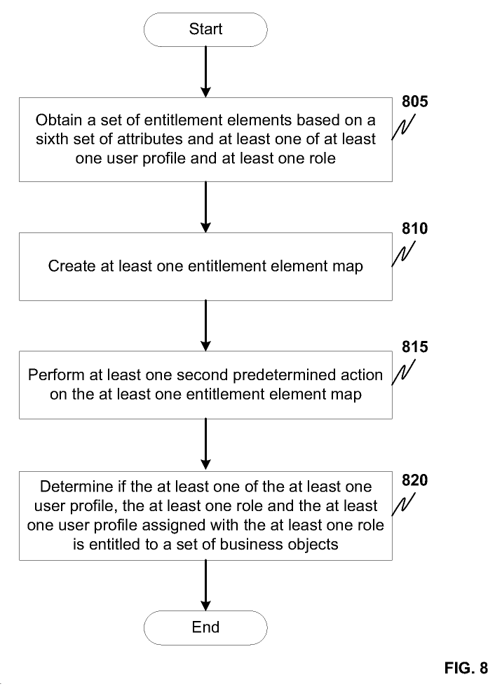

Referring to FIG. 8, a flowchart for facilitating security management using an attributes-based entitlements verification component in an electronic network, in accordance with an embodiment of the present invention is shown. At step 805, the attributes-based entitlements verification component facilitates obtaining a set of entitlement elements based on a sixth set of attributes and one or more of at least one user profile and at least one role. In an exemplary embodiment of the present invention, the entitlement elements can be for instance small, medium and large customer segments or products such as personal loans and overdrafts. The sixth set of attributes comprises an element identifier, an element name, an element business type, an element status and an element authorization status. Table. 9 illustrates the characteristics of the sixth set attributes in accordance with an embodiment of the present invention.

TABLE 9

| The sixth set of | Type and | Mandatory | |
|---|---|---|---|
| attributes | Length | requirement | Description |
| Element Identifier | Alphanumeric (20) | Yes | The element identifier denotes a unique |
| | | | identifier for each entitlement element |
| | | | belonging to the set of entitlement |
| | | | elements based on which, entitlements for |
| | | | the at least one user profile or the at least |
| | | | one role can be defined |
| Element Name | Alphanumeric | Yes | The element name denotes a name or a |
| | (100) | | description for each entitlement element |
| | | | belonging to the set of entitlement |
| | | | elements |
| Element Business | Selection | Yes | The element business type indicates a type |
| Type | | | corresponding to each entitlement element |
| | | | belonging to the set of entitlement |
| | | | elements |
| Element status | Alphanumeric (10) | Yes | The element status specifies the active or |
| | | | inactive state of each entitlement element |
| | | | belonging to the set of entitlement |
| | | | elements |
| Element | Alphanumeric (10) | Yes | The element authorization status indicates |
| authorization status | | | an “approved”, “rejected” or “pending |
| | | | approval” state corresponding to each |
| | | | entitlement element belonging to the set of |
| | | | entitlement elements |

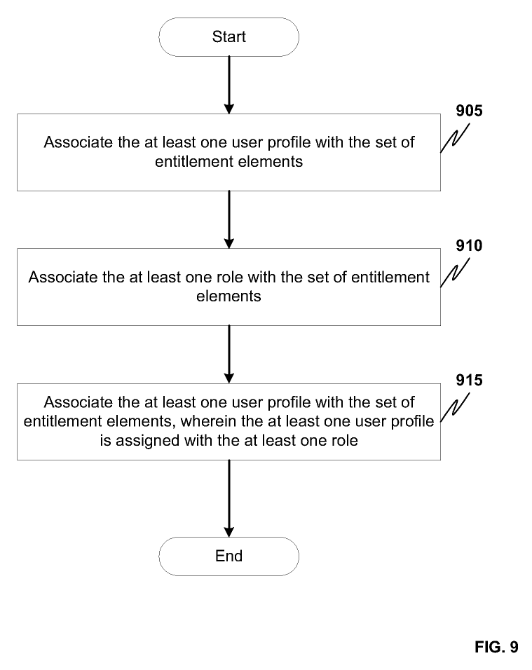

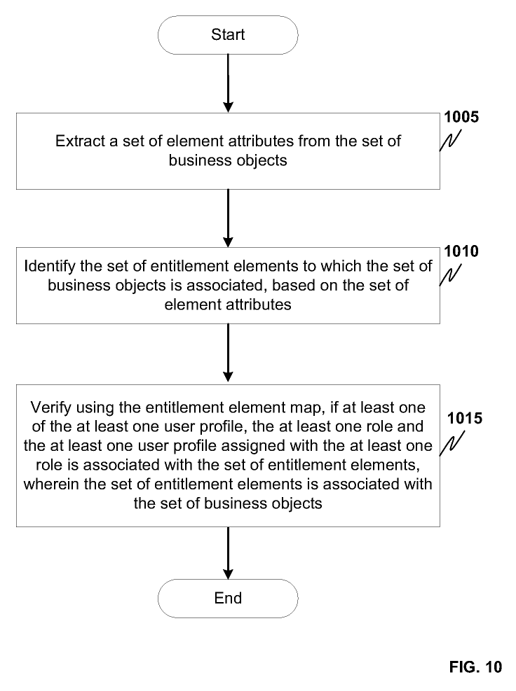

At step 810, the attributes-based entitlements verification component facilitates creating one or more entitlement element maps. This is further explained in detail in conjunction with FIG. 9. The attributes-based entitlements verification component facilitates performing a second predetermined action on one or more entitlement element maps at step 815. The second predetermined action comprises one or more of a creating action, a deleting action, a modifying action, an authorizing action, a rejecting action and a searching action. Moreover, the entitlements of one or more of the at least one user profile, the at least one role and the at least one user profile assigned with the at least one role to a set of business objects is determined at step 820. The determining step 820 is further explained in detail in conjunction with FIG. 10.

Turning to FIG. 9, a flowchart of a method for creating one or more entitlement element maps, in accordance with an embodiment of the present invention is shown. At step 905, the attributes-based entitlements verification component associates the at least one user profile or at least one role with the set of entitlement elements. Further at step 910, the attributes-based entitlements verification component facilitates creating one or more entitlement element maps by associating the at least one role with the set of entitlement elements. Moreover at step 915, the one or more entitlement element maps can be created by associating the at least one user profile or at least one role with the set of entitlement elements.

FIG. 10 is a flowchart of a method for determining if one or more of at least one user profile, at least one role and at least one user profile assigned with at least one role are entitled to a set of business objects, in accordance with an embodiment of the present invention. When a set of business objects is provided as an input to the attributes-based entitlements verification component, along with one or more of the at least one user profile, the at least one role and the at least one user profile assigned with the at least one role, a set of element attributes is extracted from the set of business objects at step 1005. Subsequent to extracting the set of element attributes, the set of entitlement elements to which the set of business objects has association is identified at step 1010 based on the element attributes. Further at step 1015, the association of one or more of the at least one user profile, the at least one role and the at least one user profile assigned with the at least one role, with the set of entitlement elements is verified using the entitlement element map. Moreover, the set of entitlement elements is associated with the set of business objects. Based on the verification performed at step 1015, the attributes-based entitlements verification component determines if one or more of the at least one user profile, the at least one role and the at least one user profile assigned with the at least one role is entitled to the set of business objects.

The attributes-based entitlements verification component facilitates creating the one or more entitlement element maps by obtaining a set of entitlement element attributes. The entitlement element attributes comprises a user identifier, a role identifier, an element type and an element. Table. 10 illustrate the characteristics of the set of entitlement element attributes in accordance with an embodiment of the present invention.

TABLE 10

| The set of | | | |
|---|---|---|---|
| entitlement | Type and | Mandatory | |
| element attributes | Length | requirement | Description |
| User Identifier | Selection | Either user identifier | The user identifier denotes a user |
| | | or role identifier is | profile to which an entitlement |
| | | mandatory. Both the | element from the set of entitlement |
| | | user identifier and the | elements is being associated with |
| Role Identifier | Selection | role identifier can be | The role identifier denotes a role to |
| | | specified at the same | which an entitlement element from |
| | | time. | the set of entitlement elements is |
| | | | being associated with |
| Element Type | Selection | | The element type is employed to |
| | | | filter the entitlement element |
| | | | belonging to the set of entitlements |
| | | | element based on a type |
| | | | corresponding to the entitlement |
| | | | element |
| Element | Selection | Yes | An element denotes the entitlement |
| | | | element from the set of entitlement |
| | | | elements to which one or more of |
| | | | the at least one user profile and the |
| | | | at least one role is going to be |
| | | | entitled |

During runtime of the attributes-based entitlements verification component, when a user having a certain user profile and at least one role seeks to access the set of business objects, the attributes-based entitlements verification component verifies the entitlements corresponding to the user profile of user based on the entitlement element maps and accordingly allows or denies access to the set of business objects.

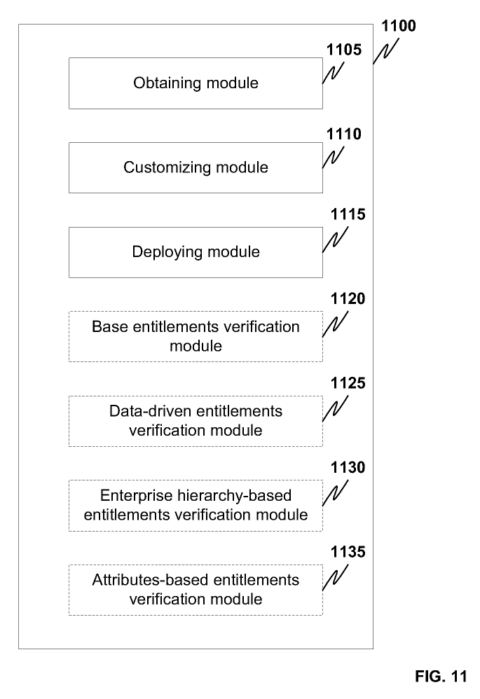

Referring to FIG. 11, a block diagram of a system 1100 for facilitating security management in an electronic network is shown. System 1100 comprises an obtaining module 1105, a customizing module 1110, a deploying module 1115 and a set of entitlements verification modules. The set of entitlements verification modules comprises a base entitlements verification module 1120, a data-driven entitlements verification module 1125, an enterprise hierarchy-based entitlements verification module 1130 and an attributes-based entitlements verification module 1135. Obtaining module 1105 facilitates obtaining a set of criteria corresponding to a security requirement of an enterprise. The set of criteria is obtained for the purpose of analyzing the deployment of security management solutions in the electronic network. In an exemplary embodiment of the present invention, system 1100 can obtain the set of criteria from a security administrator.

Customizing module 1110 facilitates customizing a set of entitlements verification modules based on the set of criteria to obtain a customized set of entitlements verification modules. The customized set of entitlements verification modules comprises one or more entitlements verification modules from the set of entitlements verification modules. In an exemplary embodiment of the present invention, customizing module 1110 can analyze the set of criteria and provide a security administrator with a list of choices for selecting the set entitlements verification modules. Deploying module 1115 of system 1100 facilitates deployment of the customized set of entitlements verification modules in the electronic network.

Base entitlements verification module 1120 is configured to facilitate a user to perform a first predetermined action on one or more of at least one role and at least one user profile. The first predetermined action comprises one or more of a creating action, an editing action, an updating action, a searching action, an approving action and a rejecting action. Further, base entitlements verification module 1120 is configured to facilitate the user to associate a set of functions with the at least one role and further configured to map the at least one role to the at least one user profile. Base entitlements verification module 1120 provides a set of base entitlements verification API modules. Using the set of base entitlements verification API modules, base entitlements verification module 1120 can be integrated with other external applications. In an embodiment of the present invention, the set of base entitlements verification API modules comprises an is Active method, a getAllFunctions method, a getFunctionsForUser method, a getFunctionsForRole method, a getDefaultRoleForUser method, a getUsersForRole method, a getRolesForUser method, a getUserProfileInfo method, a getUserprofileInfos method and an is Authorized method. Table. 11 illustrates the characteristics of the set of base entitlements verification API modules in accordance with an embodiment of the present invention.

TABLE 11

| Base entitlements | | |
|---|---|---|
| verification API | | |
| modules | Description | Returns |
| isActive | The isActive method can be called to | The isActive method returns a |
| | find whether a user profile is Active or | Boolean value “True”, if a user |
| | Inactive based on the active or inactive | profile is active and returns a value |
| | state of the user profile | “False” if a user profile is inactive |
| getAllFunctions | The getAllFunctions method returns a | The getAllFunctions method returns |
| | list of functions that is supported by | a list of all the functions supported |
| | base entitlements verification module | by the base entitlements verification |
| | 1120 | module 1120 |
| getFunctionsForUser | The getFunctionsForUser method can | The getFunctionsForUser method |
| | be called to identify functions that are | returns a list of all the functions to |
| | associated with a user profile. Initially, | which a user profile has |
| | a list of roles to which a user profile is | entitlements |
| | associated is queried and consequently, | |
| | base entitlements verification module | |
| | 1120 returns a set of all functions to | |
| | which the list of roles have | |
| | entitlements | |
| getFunctionsForRole | The getFunctionsForRole method can | The getFunctionsForRole method |
| | be called to identify a set of functions | returns a list of all the functions to |
| | associated with a role. Base | which a role has entitlements |
| | entitlements verification module 1120 | |
| | queries the association between a user | |
| | profile and a role and returns the set of | |
| | functions associated with the role | |
| getDefaultRoleForUser | The getDefaultRoleForUser method | The getDefaultRoleForUser method |
| | can be called to identify a default role | returns the role identifier for a |
| | associated with a user profile. If more | default role. |
| | than one role is associated with the | |
| | user profile, only one of the roles may | |
| | be marked as the default role for the | |
| | user profile | |
| getUsersForRole | The getUsersForRole method can be | The getUsersForRole method |
| | called to identify a user profile | returns a list of user identifiers that |
| | associated with a role | are mapped with a certain role |
| getRolesForUser | The getRolesForUser method can be | The getRolesForUser method |
| | called to identify a role associated with | returns a list of role identifiers to |
| | a user profile | which a user profile is mapped |
| getUserProfileinfo | The getUserProfileInfo method can be | The getUserProfileinfo method |
| | called to identify the details of a user | returns the details of a user profile |
| | profile | |
| getUserProfileInfos | The getUserProfileInfos can be called | The getUserProfileInfos method |
| | to identify the details of all the user | returns a Llist of user profiles |
| | profiles created in the system 1100 | |
| isAuthorized | The isAuthorized method can be called | The isAuthorized method returns a |
| | to verify whether a user profile or a | Boolean value “True” if a user |
| | role or a user profile assigned with a | profile and/or role combination is |
| | role is entitled to perform a certain | entitled to perform a certain |
| | function | function |
| | | FALSE - If a user profile and/or |
| | | role combination is not entitled to |
| | | perform a certain function. |

Data-driven entitlements verification module 1125 is configured to facilitate the user to obtain a set of data entitlement rules, a set of business objects and one or more of at least one user profile and at least one role. Further, data-driven entitlements verification module 1125 is configured to facilitate the user to store the set of data entitlement rules in an entitlement rules database. Moreover, data-driven entitlements verification module 1125 is configured to facilitate the user to determine whether one or more of the at least one user profile and the at least one role is entitled to the set of business objects. Further, data-driven entitlements verification module 1125 is configured to facilitate the user to associate the set of business objects to one or more of the at least one user profile and the at least one role, if one or more of the at least one user profile and the at least one role is not entitled to the set of business objects.

Data-driven entitlements verification module 1125 provides a set of data-driven entitlements verification API modules. The set of data-driven entitlements verification API modules facilitates external applications to be integrated with data-driven entitlements verification module 1125 for facilitating entitlements verification using data entitlement rules. The set of data-driven entitlements verification API modules comprises a first is Authorized method and a second is Authorized method. Table. 12 illustrates the characteristics of the set of data-driven entitlements verification API modules in accordance with an embodiment of the present invention.

TABLE 12

| Data-driven | | |
|---|---|---|
| entitlements | | |
| verification API | | |
| modules | Description | Returns |
| isAuthorized | The isAuthorized method can be | The isAuthorized method returns a |
| | called to check if a user profile | Boolean value “True” if a user profile |
| | or a role or a user profile | and/or role combination is entitled to |
| | assigned with a role, has | a certain business object |
| | entitlements to a business object | The isAuthorized method returns a |
| | | Boolean value “False” if a user profile |
| | | and/or role combination does not |
| | | have entitlements to a certain business |
| | | object |
| isAuthorized | The isAuthorized method can be | The isAuthorized method returns a |
| | called to check whether a user | subset of business objects to which the |
| | profile or a role or a user profile | user profile and/or role combination |
| | assigned with a role, has | is entitled to perform a certain |
| | entitlements to a set of business | function |
| | objects | |

Enterprise hierarchy-based entitlements verification module 1130 of system 1100 is configured to facilitate a user to obtain a data corresponding to an enterprise hierarchy. Further, enterprise hierarchy-based entitlements verification module 1130 is configured to facilitate the user to generate a tree structure based on the data corresponding to the enterprise hierarchy. The tree structure corresponding to the enterprise hierarchy comprises a plurality of levels wherein each of the plurality of levels comprises one or more nodes. Enterprise hierarchy-based entitlements verification module 1130 is further configured to facilitate the user to link one or more nodes with one or more other nodes corresponding to the tree structure based on a fourth set of attributes.

Moreover, enterprise hierarchy-based entitlements verification module 1130 is configured to facilitate the user to create an association between one or more nodes corresponding to each of the plurality of levels of the tree structure and one or more of at least one user profile and at least one role, based on a fifth set of attributes. When a set of business objects is provided as input to enterprise hierarchy-based entitlements verification module 1130 along with one or more of the at least one user profile, the at least one role and the at least one user profile assigned with the at least one role, enterprise hierarchy-based entitlements verification module 1130 determines if the one or more of the at least one user profile, the at least one role and the at least one user profile assigned with the at least one role is entitled to the set of business objects. Furthermore, enterprise hierarchy-based entitlements verification module 1130 is configured to facilitate the user to maintain the tree structure by performing one or more of adding one or more nodes to the tree structure and removing one or more nodes from the tree structure.

The enterprise hierarchy-based entitlements verification module 1130 provides a set of enterprise hierarchy-based entitlements verification API modules. The set of enterprise hierarchy-based entitlements verification API modules facilitates external applications to be integrated with enterprise hierarchy-based entitlements verification module 1130 for facilitating entitlements verification using the enterprise hierarchy. The set of enterprise hierarchy-based entitlements verification API modules comprises a getUserForHierarchyNode method, a getRolesForHierarchyNode method, getFunctionsForUserForHierarchyNode method, getFunctionsForRoleForHierarchyNode method, a validateUserForHierarchyNode method and a validateRoleForHierarchyNode method. Table. 13 illustrates the characteristics of the set of enterprise hierarchy-based entitlements verification API modules in accordance with an embodiment of the present invention.

TABLE 13

| Enterprise hierarchy-based | | |
|---|---|---|
| entitlements verification API | | |
| modules | Description | Returns |
| getUsersForHierarchyNode | The getUserForHierarchyNode method | The getUserForHierarchyNode method |
| | can be called to obtain a list of user | returns a list of user profiles and the |
| | profiles that correspond to a specific | scopes associated the list of user |
| | enterprise hierarchy | profiles |
| getRolesForHierarchyNode | The getRolesForHierarchyNode | The getRolesForHierarchyNode |
| | method can be called to obtain a list of | method returns the list of roles along |
| | roles that have been entitled to a node | with their associated scopes for the |
| | in the enterprise hierarchy | node in the enterprise hierarchy |
| getFunctionsForUserForHierarchyNode | The | The |
| | getFunctionsForUserForHierarchyNode | getFunctionsForUserForHierarchyNode |
| | method can be called to obtain a list of | method returns a list of functions to |
| | activities that a user profile can perform | which the user profile is entitled for the |
| | on a node in the enterprise hierarchy | given node in the enterprise hierarchy |
| getFunctionsForRoleForHierarchyNode | The | The |
| | getFunctionsForRoleForHierarchyNode | getFunctionsForRoleForHierarchyNode |
| | method can be called to obtain the list | method returns a list of functions to |
| | of activities that a role can perform on a | which the role is entitled for the node in |
| | node in the enterprise hierarchy | the enterprise hierarchy |
| validateUserForHierarchyNode | The validateUserForHierarchyNode | The validateUserForHierarchyNode |
| | method can be called to check if a user | method returns a Boolean value “True” |
| | profile has entitlements to a node for | if the user profile is entitled to the node |
| | performing an activity on the node | and returns a Boolean value “Fals” if |
| | | the user profile is not entitled to the |
| | | node |
| validateRoleForHierarchyNode | The validateRoleForHierarchyNode | The validateRoleForHierarchyNode |
| | method can be called to check if a role | method returns a Boolean value “True” |
| | has entitlements to a node for | if the role is entitled to the node and |
| | performing an activity on the node | returns a Boolean value “False” if the |
| | | role is not entitled to the node |

Each of the set of enterprise hierarchy-based entitlements verification API modules provides an additional API module having a getOrganizationalNode method. The getOrganizationalNode method can be called using a string denoting a type of the node pertaining to the enterprise hierarchy. Accordingly, the getOrganizationalNode method returns the value of the attribute that denotes the node corresponding to the enterprise hierarchy for the specified node type. For example, if the getOrganizationalNode method is invoked on a customer profile having a node type value as “branch”, the getOrganizationalNode method may return the branch code to which customer profile is associated with.

Attributes-based entitlements verification module 1135 of system 1100 is configured to facilitate the user to obtain a set of entitlement elements based on a sixth set of attributes and one or more of at least one user profile and at least one role. Further, attributes-based entitlements verification module 1135 is configured to facilitate the user to create one or more entitlement element maps. One or more entitlement element maps can be created by associating the at least one user profile with the set of entitlement elements or associating the at least one role with the set of entitlement elements or associating the at least one user profile assigned with the at least one role with the set of entitlement elements. When a set of business objects is provided as input to attributes-based entitlements verification module 1135 along with one or more of the at least one user profile, the at least one role and the at least one user profile assigned with the at least one role, attributes-based entitlements verification module 1135 determines if the one or more of the at least one user profile, the at least one role and the at least one user profile assigned with the at least one role is entitled to the set of business objects. Moreover, attributes-based entitlements verification module 1135 is further configured to facilitate the user to perform a second predetermined action corresponding to one or more entitlement element maps. The second predetermined action comprises one or more of a creating action, a deleting action, a modifying action, an authorizing action, a rejecting action and a searching action.

Attributes-based entitlements verification module 1135 provides a set of attributes-based entitlements verification API modules. The set of attributes-based entitlements verification API modules facilitates external applications to be integrated with attributes-based entitlements verification module 1135 for facilitating entitlements verification based on a set of entitlement elements. The set of attributes-based entitlements verification API modules comprises a getElementForUserRole method, a validateUserForElement method and a validateRoleForElement method. Table. 14 illustrates the characteristics of the set of attributes-based entitlements verification API modules in accordance with an embodiment of the present invention.

TABLE 14

| Attributes-based | | |
|---|---|---|
| entitlements | | |
| verification API | | |
| modules | Description | Returns |
| getElementForUserRole | The getElementForUserRole | The getElementForUserRole |
| | method can be called to obtain a | method returns a list of entitlement |
| | list of entitlement element values | element values for a given |
| | for a given entitlement element | entitlement element type to which a |
| | type to which a user profile or a | user profile or a role or a user |
| | role or a user profile assigned with | profile assigned with a role has |
| | a role has entitlements | entitlements |
| validateUserForElement | The validateUserForElement | The validateUserForElement |
| | method can be called to check if | method returns a Boolean value |
| | the user profile is entitled to an | “TRUE” if the user profile is |
| | entitlement element | entitled to the entitlement element |
| | | and returns a Boolean value |
| | | “FALSE” if the user profile is not |
| | | entitled to the entitlement element |
| validateRoleForElement | The validateRoleForElement | The validateRoleForElement |
| | method can be called to check if a | method returns a Boolean value |
| | role is entitled to an entitlement | “TRUE” if the role is entitled to the |
| | element | entitlement element and returns a |
| | | Boolean value “FALSE” if the role |
| | | is not entitled to the entitlement |
| | | element |

Each of the set of attributes-based entitlements verification API modules provides an additional API module having a getElement method. The getElement method can be called by providing a string input denoting a type corresponding to the entitlement element. The getElement method returns the entitlement element if a value is present for a business object to which the entitlement element belongs. On the contrary, if the business object to which the entitlement element belongs does not have a value, a “NULL” value is returned by the getElement method.

Further, various embodiments of the invention provide method and system for facilitating security management in an electronic network. The system provides greater flexibility for facilitating security management in the electronic network. The architecture realized by the system offers high scalability in managing security of an enterprise. Moreover, the enterprise hierarchy-based entitlements verification component and the attributes-based entitlements verification component offer a complex level of security management that can be highly beneficial for managing security of medium and large scale enterprises.

The method for facilitating security management in an electronic network, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which are capable of implementing the steps that constitute the method of the invention.

The computing device executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the computing device to perform specific tasks such as the steps that constitute the method of the invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the computing device may be in response to user commands, or in response to results of previous processing or in response to a request made by another computing device.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for facilitating security management in an electronic network, the method comprising:
obtaining a set of criteria corresponding to a security requirement of an enterprise;
customizing a set of entitlements verification components based on the set of criteria to obtain a customized set of entitlements verification components, wherein the customized set of entitlements verification components comprises one or more entitlements verification components from the set of entitlements verification components; and
deploying the customized set of entitlements verification components in the electronic network.

2. The method of claim 1, wherein the set of entitlements verification components comprises at least:
a base entitlements verification component;
a data-driven entitlements verification component;
an enterprise hierarchy-based entitlements verification component; and
an attributes-based entitlements verification component.

3. The method of claim 2, wherein the base entitlements verification component facilitates:
performing at least one first predetermined action corresponding to at least one of at least one role and at least one user profile, the at least one role and the at least one user profile corresponding to the enterprise;
associating a set of functions with the at least one role; and
mapping the at least one role to the at least one user profile.

4. The method of claim 3, wherein the first predetermined action comprises at least one of a creating action, an editing action, an updating action, a searching action, an approving action and a rejecting action.

5. The method of claim 3, wherein the at least one role is mapped to the at least one user profile based on at least one of a first set of attributes corresponding to the at least one user profile, a second set of attributes corresponding to the at least one role and a default role.

6. The method of claim 2, wherein the data-driven entitlements verification component facilitates:
obtaining a set of data entitlement rules, a set of business objects and at least one of at least one user profile and at least one role;
storing the set of data entitlement rules in an entitlement rules database;
associating at least one of the at least one user profile and the at least one role with the set of data entitlement rules based on a third set of attributes; and
performing one of:
determining if the at least one of the at least one user profile and the at least one role is entitled to the set of business objects; and
identifying one or more of business objects belonging to the set of business objects to which the at least one user profile or the at least one role is entitled.

7. The method of claim 6, wherein the determining step comprises:
extracting a set of data attributes from the set of business objects; and
applying the set of data entitlement rules on the set of data attributes.

8. The method of claim 6, wherein the identifying step comprises:
extracting a set of data attributes from the set of business objects; and
applying the set of data entitlement rules on the set of data attributes.

9. The method of claim 2, wherein the enterprise hierarchy-based entitlements verification component facilitates:
obtaining a data corresponding to an enterprise hierarchy, the enterprise hierarchy corresponding to the enterprise;
generating a tree structure based on the data corresponding to the enterprise hierarchy, wherein the tree structure comprises a plurality of levels, each of the plurality of levels comprising at least one node;
linking the at least one node with at least one other node based on a fourth set of attributes;
creating an association between the at least one node corresponding to each of the plurality of levels of the tree structure and at least one of at least one user profile, at least one role and at least one user profile assigned with at least one role based on a fifth set of attributes; and
determining if the at least one of the at least one user profile, the at least one role and the at least one user profile assigned with the at least one role is entitled to a set of business objects.

10. The method of claim 9, wherein the enterprise hierarchy-based entitlements verification component further facilitates maintaining the tree structure, wherein maintaining the tree structure comprises performing at least one of adding at least one node to the tree structure, editing the association between the at least one node corresponding to each of the plurality of levels of the tree structure and the at least one user profile and the at least one role and removing at least one node from the tree structure.

11. The method of claim 9, wherein the creating step comprises attaching a scope to the association between the at least one node and the at least one user profile, wherein the at least one user profile is assigned the at least one role.

12. The method of claim 11, wherein the scope corresponds to providing the at least one user profile with at least one of:
a self-access privilege to the at least one node associated with the at least one user profile, wherein the at least one user profile is assigned with the at least one role;
an all-access privilege to the at least one other node; and
a type-based access privilege to at least one portion of the tree structure, the at least one portion of the tree structure comprising one or more nodes.

13. The method of claim 9, wherein the determining step comprises:
extracting a set of node attributes from the set of business objects;
identifying the at least one node to which the set of business objects is associated, based on the set of node attributes; and
verifying if the at least one of the at least one user profile, the at least one role and the at least one user profile assigned with the at least one role is associated with the at least one node, wherein the at least one node is associated with the set of business objects.

14. The method of claim 2, wherein the attributes-based entitlements verification component facilitates:
obtaining a set of entitlement elements based on a sixth set of attributes and at least one of at least one user profile and at least one role;
creating at least one entitlement element map;
performing a second predetermined action corresponding to the at least one entitlement element map; and
determining if the at least one of the at least one user profile, the at least one role and the at least one user profile assigned with the at least one role is entitled to a set of business objects.

15. The method of claim 14, wherein creating the at least one entitlement element map comprises performing at least one of:
associating the at least one user profile with the set of entitlement elements;
associating the at least one role with the set of entitlement elements; and
associating the at least one user profile with the set of entitlement elements, wherein the at least one user profile is assigned with the at least one role.

16. The method of claim 14, wherein the second predetermined action comprises at least one of, a creating action, a deleting action, a modifying action, an authorizing action, a rejecting action and a searching action.

17. The method of claim 14, wherein the determining step comprises:
extracting a set of element attributes from the set of business objects;
identifying the set of entitlement elements to which the set of business objects is associated, based on the set of element attributes; and
verifying using the entitlement element map, if at least one of the at least one user profile, the at least one role and the at least one user profile assigned with the at least one role is associated with the set of entitlement elements, wherein the set of entitlement elements is associated with the set of business objects.

18. A system for facilitating security management in an electronic network, the system comprising:
an obtaining module obtaining a set of criteria corresponding to a security requirement of an enterprise;
a customizing module customizing a set of entitlements verification modules based on the set of criteria to obtain a customized set of entitlements verification modules, wherein the customized set of entitlements verification modules comprises one or more entitlements verification modules from the set of entitlements verification modules; and
a deploying module deploying the customized set of entitlements verification modules in the electronic network.

19. The system of claim 18, wherein the set of entitlements verification modules comprises at least:
a base entitlements verification module;
a data-driven entitlements verification module;
an enterprise hierarchy-based entitlements verification module; and
an attributes-based entitlements verification module.

20. The system of claim 19, wherein the base entitlements verification module is configured to facilitate a user to:
perform at least one first predetermined action on at least one of at least one role and at least one user profile, the at least one role and the at least one user profile corresponding to the enterprise, the first predetermined action comprising at least one of a creating action, an editing action, an updating action, a searching action, an approving action and a rejecting action;
associate a set of functions with the at least one role; and
map the at least one role to the at least one user profile.

21. The system of claim 19, wherein the data-driven entitlements verification module is configured to facilitate a user to:
obtain a set of data entitlement rules, a set of business objects and at least one of at least one user profile and at least one role;
store the set of data entitlement rules in an entitlement rules database; and
perform one of:
determine if the at least one of the at least one user profile and the at least one role is entitled to the set of business objects; and
associate the set of business objects to the at least one of the at least one user profile and the at least one role, if the at least one of the at least one user profile and the at least one role is not entitled to the set of business objects.

22. The system of claim 19, wherein the enterprise hierarchy-based entitlements verification module is configured to facilitate a user to:
obtain a data corresponding to an enterprise hierarchy, the enterprise hierarchy corresponding to the enterprise;
generate a tree structure based on the data corresponding to the enterprise hierarchy, wherein the tree structure comprises a plurality of levels, each of the plurality of levels comprising at least one node;
link the at least one node with at least one other node based on a fourth set of attributes;
create an association between the at least one node corresponding to each of the plurality of levels of the tree structure and at least one of at least one user profile and at least one role based on a fifth set of attributes;
maintain the tree structure by performing at least one of adding at least one node to the tree structure and removing at least one node from the tree structure.
determine if the at least one of the at least one user profile, the at least one role and the at least one user profile assigned with the at least one role is entitled to a set of business objects; and

23. The system of claim 19, wherein the attributes-based entitlements verification module is configured to facilitate a user to:
obtain a set of entitlement elements based on a sixth set of attributes and at least one of at least one user profile and at least one role;
create at least one entitlement element map by performing at least one of associating the at least one user profile with the set of entitlement elements, associating the at least one role with the set of entitlement elements and associating the at least one user profile with the set of entitlement elements, wherein the at least one user profile is assigned with the at least one role; and
perform at least one second predetermined action corresponding to the at least one entitlement element map, wherein the second predetermined action comprising at least one of a creating action, a deleting action, a modifying action, an authorizing action, a rejecting action and a searching action.
determine if the at least one of the at least one user profile, the at least one role and the at least one user profile assigned with the at least one role is entitled to a set of business objects

24. A computer program product comprising a computer usable medium having a computer readable program method for facilitating security management in an electronic network, wherein the computer readable program when executed on a computer causes the computer to:
obtain a set of criteria corresponding to a security requirement of an enterprise;
customize a set of entitlements verification components based on the set of criteria to obtain a customized set of entitlements verification components, wherein the customized set of entitlements verification components comprises one or more entitlements verification components from the set of entitlements verification components; and
deploy the customized set of entitlements verification components in the electronic network.
